(19) United States
(12) Patent Application Publication
(10) Pub. No.: US 2017/0132888 A1
(43) Pub. Date: May 11, 2017

(54) INTRUDER DETECTION DEVICES, METHODS AND SYSTEMS

(71) Applicant: Cocoon Alarm Limited, Leeds (GB)

(72) Inventors: Daniel James Conlon, Yorkshire (GB); John James Berthels, Yorkshire (GB)

(21) Appl. No.: 15/318,303

(22) PCT Filed: Mar. 30, 2015
(86) PCT No.: PCT/GB2015/050964

§ 371 Date: Dec. 12, 2016

(30) Foreign Application Priority Data
Jun. 26, 2014 (GB) 1411368.2

(51) Int. Cl. G08B 13/16; H04L 29/06; H04W 12/06; G08B 29/18; G08B 15/00

(52) U.S. Cl. CPC G08B 13/1672; G08B 29/188; G08B 15/004; H04W 12/06; H04L 63/102

(57) ABSTRACT

Devices, methods and systems for detecting an unauthorised person. The method comprises monitoring an indication of whether an authorized person is present within a detection space and detecting activity within the detection space. If activity is detected within the detection space and the monitoring indicates that an authorised person is present within the detection space, the method further comprises determining based on the detected activity whether an unauthorised person is present within the detection space.

The invention relates to an intruder detection method and system. In particular, the invention detects the intrusion of an unauthorised person into a detection space. Certain embodiments of the invention relate to detection of an intruder in an enclosed space for instance a building or a room within a building. Advantageously, certain embodiments of the invention are able to distinguish between an authorised person and an intruder.

### BACKGROUND

Intruder detection systems (also known as security systems or burglar alarm systems) for detecting unauthorised entry into buildings usually require authorised persons to disarm and arm the system when entering and exiting a secured area. Users typically validate their authority to arm or disarm a system at a control panel using a keyed pass code or hardware “key fob” device. Intruder detection systems typically consist of a controller and one or more sensors for instance a motion detector for monitoring interior areas and door sensors for monitoring the perimeter of a secured area. The secured area may also be referred to as a protected area or space, and may comprise a detection space within which activity associated with a human may be detected. Typically, multiple sensors are provided and typically at least some of these are remote from the controller. Remote sensors are coupled to the controller via a wired connection or wirelessly. When the system is armed and a sensor detects the possible presence of a person (for instance by detecting movement or a breach of the perimeter surrounding the secured area) a response is triggered by the controller. The response may include an audible or visible alarm signal. The response may include contacting a remote monitoring station, for instance a private security company, who may take follow up action to investigate why the intruder detection system has been triggered.

Some intruder detection systems allow certain sensors or areas to be armed during authorised occupancy of the building. For example some residential intruder detection systems may be “part set” or operate in a “stay mode” whilst occupants are sleeping such that only movement or events outside sleeping areas triggers a response from the controller.

While known intruder detection systems may be highly effective if used correctly, users may forget, become disinclined or lose the means (knowledge of the pass code or loss of a physical key fob) to arm and disarm the intruder detection system. There is a risk that the intruder detection system can remain inactivated, preventing it from detecting an intruder within the secured area. To address this, some systems use GPS on authorised users' mobile device to arm and disarm as phones move out of or into the secured area but the approach does not handle the “part set” case.

Furthermore, users may forget or be disinclined to appropriately control an intruder detection system, for instance by placing the system into a “part set” mode at night time. The result may either be that the intruder detection system is fully disabled overnight, or the system may be fully set resulting in a high risk of an authorised person triggering a response from the controller.

It is an aim of certain embodiments of the present invention to provide an intruder detection system that is less reliant upon a user to correctly set and control the system. Certain embodiments of the invention are entirely or substantially passive on the part of user.

### BRIEF SUMMARY OF THE DISCLOSURE

An advantage of certain embodiments of the present invention is that an intruder detection system may remain in an armed state, which avoids the need for authorised users to arm and disarm the system. Certain embodiments of the present invention allow intruders to be identified even when a building is occupied by authorised users. Advantageously, certain embodiments of the present invention improve upon conventional intruder detection systems by the use of intruder detection methods that are not reliant upon a sensor being in line-of-sight of an intruder. For instance, certain embodiments of the present invention make use of analysis of sound and air pressure changes to protect several rooms or a whole building from a single sensor, avoiding the need to install and maintain many sensors.

According to a first aspect of the present invention there is provided a method of detecting an unauthorised person, the method comprising: monitoring an indication of the presence of an authorised person within a detection space; and detecting activity within the detection space; wherein if activity is detected within the detection space and the monitoring indicates that an authorised person is present within the detection space, the method further comprises determining based on the detected activity whether an unauthorised person is present within the detection space. The monitoring may comprise monitoring an indication of whether an authorised person is present within a detection space.

Determining whether an unauthorised person is present within the detection space may comprise: comparing detected activity to activity associated with the presence of an authorised person within the detection space; and determining whether an unauthorised person is present within the detection space based upon the result of that comparison.

Monitoring an indication of the presence of an authorised person within the detection space may comprise identifying at least one authorised person whose presence within the detection space is indicated; and wherein determining whether an unauthorised person is present within the detection space comprises or further comprises: comparing detected activity to activity associated with the presence of at least one identified authorised person within the detection space; and determining whether an unauthorised person is present within the detection space based upon the result of that comparison.

If activity is detected within the detection space and the monitoring indicates that there are no authorised persons present within the detection space, the method may further comprise determining based on the detected activity whether an unauthorised person is present within the detection space.

The determination may be further based on an indication that an authorised person is approaching the detection space.

Determining whether an unauthorised person is present within the detection space may comprise or further comprise: comparing detected activity to activity previously determined to indicate the presence of an unauthorised person within the detection space or comparing detected activity to activity previously determined to not indicate the presence of person within the detection space; and determining whether an unauthorised person is present within the detection space based upon the result of that comparison.

If it is determined that there is not an unauthorised person present within the detection space, the method may further comprise: updating a list of activity associated with the presence of an authorised person within the detection space; updating a list of activity associated with the presence of an identified authorised person within the detection space; or updating a list of activity associated with there being no unauthorised person present within the detection space.

The determination whether an unauthorised person is present within the detection space may be further based upon a number, type or time of occurrence of previously detected activities.

Determining whether an unauthorised person is present within the detection space may comprise determining a probability of an unauthorised person being present within the detection space.

If it is determined that an unauthorised person is present within the detection space, the method may further comprise: triggering an audible or visible alarm signal; or sending an alert to an authorised person or a third party.

If it is determined that an unauthorised person is present within the detection space, the method may further comprise: comparing the detected activity to a list of at least one activity predetermined to be ignored; wherein if the result of the comparison is that the detected activity matches an activity to be ignored then the determination that an unauthorised person is present within the detection space is reversed; wherein if the result of the comparison is that the detected activity does not match an activity to be ignored then the method further comprises sending an alert to an authorised person or a third party; and wherein if in response to the alert a message is received indicating that the activity is to be ignored then the method further comprises: reversing the determination that an unauthorised person is present within the detection space; and adding the detected activity to the list of activity to be ignored.

Monitoring an indication of the presence of an authorised person within a detection space comprises: monitoring the location of a mobile device associated with an authorised user and determining whether the mobile device is within a geographical area at least partially overlapping the detection space; determining whether a mobile device associated with an authorised user is connected to a wireless network proximal to the detection space; or recognising the voice of an authorised person within the detection space.

The method may further comprise: maintaining an occupancy list indicating authorised persons whose presence is indicated in the detection space; wherein if the presence of an authorised person is indicated by determining whether a mobile device associated with an authorised user is connected to a wireless network or by recognising the voice of an authorised person, the method further comprises: determining whether the presence of the authorised person within the detection space is confirmed within a predetermined time period, and if not removing the authorised person from the occupancy list.

Detecting activity within the detection space may comprise receiving a signal from a sensor arranged to sense activity within the detection space.

The method may further comprise identifying characteristic sensor data indicative of a predetermined activity pattern or generating an activity pattern indicative of the sensor signal or variation of the sensor signal.

The sensor may be arranged to sense: audible or inaudible sound; changes in air pressure; changes in the power supply of electrical or electronic devices within the detection space; signals sent from a device carried by an authorised person; or movement.

According to a second aspect of the present invention there is provided a security device arranged to detect an unauthorised person, the security device comprising: a processing system arranged to: monitor an indication of the presence of an authorised person within a detection space; and detect activity within the detection space; wherein if activity is detected within the detection space and the monitoring indicates that an authorised person is present within the detection space, the processing system is further arranged to determine based on the detected activity whether an unauthorised person is present within the detection space.

The security device may further comprise: a network interface arranged to receive an indication of the location of a mobile device associated with an authorised user; wherein the processing system is arranged to monitor an indication of the presence of an authorised person within the detection space by determining whether the mobile device is within a geographical area at least partially overlapping the detection space.

The security device may further comprise: a sensor arranged to sense activity within the detection space; wherein the processing system is arranged to detect activity within the detection space based upon activity sensed by the sensor.

Another aspect of the invention provides a computer program comprising instructions arranged, when executed, to implement a method in accordance with any one of the above-described aspects. A further aspect provides machine-readable storage storing such a program.

### BRIEF DESCRIPTION OF THE DRAWINGS

Embodiments of the invention are further described hereinafter with reference to the accompanying drawings, in which:

FIG. 1 illustrates an intruder detection system in accordance with an embodiment of the present invention;

FIG. 2 illustrates how occupancy by authorised persons is determined; and

FIG. 3 illustrates how the presence of an unauthorised person (an intruder) is determined.

### DETAILED DESCRIPTION

An embodiment of an intruder detection system and method will now be described. The detection of an intruder is based upon the detection of activity in a detection space. The term “detection space” may be considered to be synonymous with the terms “secured area” or “protected area”. The detection space in certain embodiments may comprise the area within which a security device (described below) is located, and within which activity can be detected according to the sensitivity of sensors within the security device. In certain particular embodiments of the invention the system is arranged to detect an intruder within an enclosure or a partially or fully enclosed space. “Enclosure” may refer to an enclosed area or space for instance a building (including dwellings, schools or offices), a subdivision of a building (for instance an individual apartment within an apartment block) or one or more rooms within a building.

The term “activity” refers to any indication of an intruder or an authorised person that can be sensed. For instance, this may include any wave, vibration, sound or change in an enclosure that can be detected and that may be indicative of the presence of a person in the enclosure. According to certain embodiments of the invention an “activity pattern” may be established, measured or monitored and this term refers to data relative to an activity characterised by any or all of: detection sources, order, time of occurrence, relative separation in time, intensity/magnitude of detection and nature of the activity (for example the spectrum of sound or the type of network traffic).

Embodiments of the present invention advantageously are able, when activity is detected, to distinguish between the presence of an authorised person and an unauthorised person (an intruder). Advantageously, in certain embodiments of the invention this may be partly on the basis of monitoring occupancy of the detection space by an authorised person. “Occupancy” refers to whether an authorised person is present or is likely to be present in the detection space, or in the geographical area of the detection space as is described below. Certain embodiments of the present invention “passively monitor” occupancy, and passive monitoring refers to monitoring an authorised person's occupancy without requiring that person to interact with the system (for instance through touching, gesturing to, looking at or audibly addressing the system).

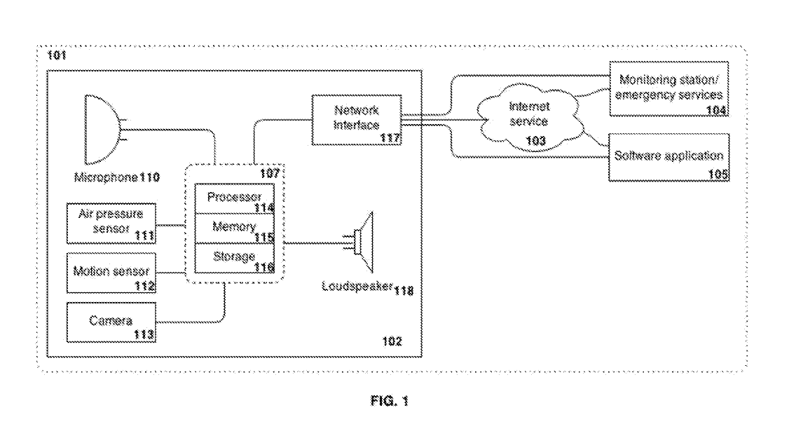

Referring now to FIG. 1, this illustrates an intruder detection system 101 according to one embodiment of the present invention suitable for detecting intruders within a detection space. In particular, the detection space may be an enclosure for instance a dwelling. However, system 101 may be used to secure other types of building and zones. The present invention is not limited to any consideration of the nature of the detection space. System 101 includes a security device 102 within or proximal to the detection space. The intruder detection system 101 also encompasses an Internet service 103, a monitoring station or emergency services 104 and a software application 105 implemented upon a mobile device. The monitoring station 104 and the software application 105 may communicate with the security device 102 either directly or via the Internet service 103.

The Internet service 103 provides a facility for distributing data between different components of the intruder detection system 101, and may for instance be implemented at a remote server such that it can be accessed from any Internet enabled device. The Internet service 103 is described in greater detail below. It will be appreciated that the present invention is not limited to the particular method by which external components of the system 101 communicate with the security device 102. In certain embodiments of the present invention there may be no connection of the security device 102 to a monitoring station or the emergency services 104.

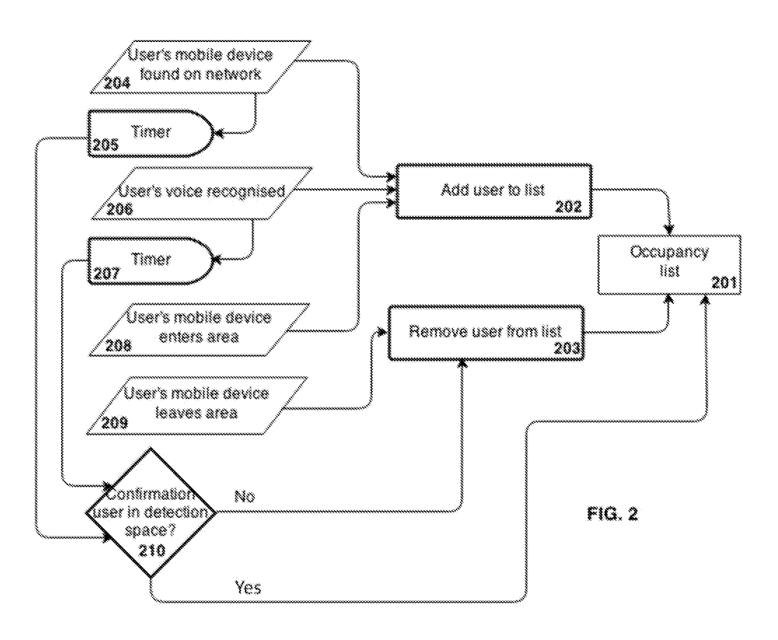

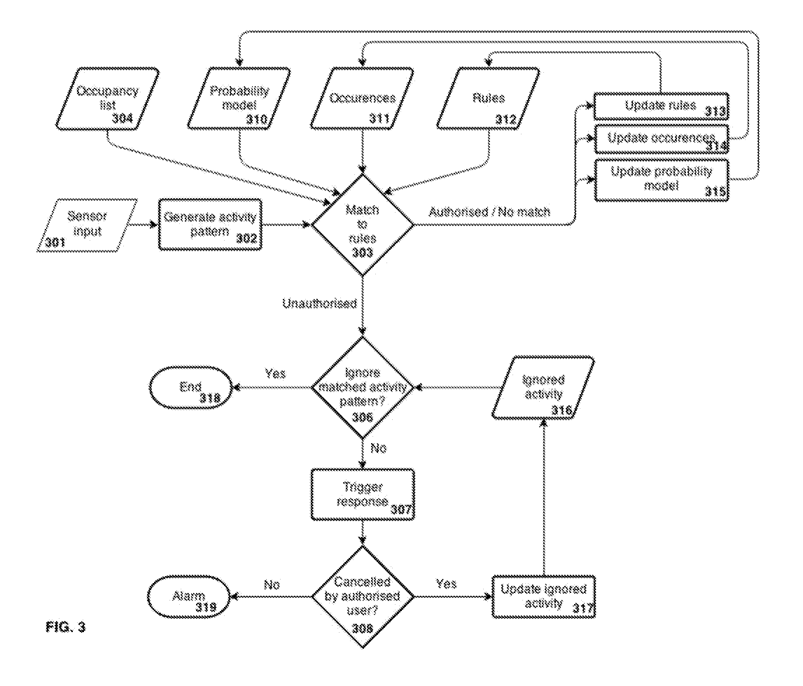

The security device 102 includes at least one network interface 117 through which device 102 may communicate with external components of the system 101 either directly or via the Internet service 103. Security device 102 further includes a processing system 107 programmed or otherwise arranged to implement the intruder detection method and associated processes described below in connection with FIGS. 2 and 3. Processing system 107 may include one or more central processing units 114, memory 115 and data storage system 116. The processing system 107 is coupled to the network interface 117 to enable the processing system 107 to communicate with the external components of the intruder detection system 101.

The additional components of the security device 102 beyond the processing system 107 may be physically located close to or packaged together with the processing system. Alternatively, they may be remotely installed, for instance in a different portion of the protected space and coupled to the processing system 107 via a wired connection or wirelessly. As such, where reference is made to a security device 102 this should be taken to refer either to a single integrated device or a collection of components functioning together as the security device.

The security device 102 may include one or more sensors arranged to detect activity within the detection zone. Certain sensors are illustrated in FIG. 1, but these are by way of non-limiting example. The sensors are coupled to the processing system 107 so that the processing system 107 receives signals indicative of activity within the detection zone.

A microphone 110 may be provided. Microphone 110 may be capable of capturing sound pressure waves in the range of human hearing, infrasonic (typically less than 20 Hz) range or ultrasonic (typically greater than 20 kHz). Electrical signals representing sound pressure changes are monitored by processing system 107 to determine if there is activity within the detection space and for breaches of its perimeter, as described below.

An air pressure sensor 111 may be provided. The air pressure sensor 111 is capable of capturing an air pressure change that occurs within a detection space when an external door or window is opened, air movement due to human movement, air movement due to doors moving, air movement due to the perimeter of the enclosure being breached, and the structure of an enclosure flexing. Air pressure sensor 111 transmits electrical signals to the processing system 107 indicating the current air pressure.

A motion sensor 112 for instance a Passive Infrared (PIR) motion sensor may be provided. Motion sensor 112 transmits a signal to processing system 107 when movement of an object in its field of view is detected.

A camera 113 may be provided. Camera 113 may be capable of capturing still and moving images of the environment in which the device 102 is located. Camera 113 transmits electronic representations of the images to processing system 107. The electronic representations of the still and moving images may be retained on the storage system 116 or at a remote storage location, for instance cloud based storage accessed through the Internet service 103 for future viewing of images, for instance through the software application 105.

The security device may further include a loudspeaker 118 capable of producing audible tones and/or audible spoken words that are intended to be heard by a user of the system 101 or by an unauthorised person in the enclosure. The content of the audio communications may be stored on the storage system 116 or transmitted from the Internet service 103 for broadcast by speaker 118.

Internet service 103 communicates with security device 102 to receive information related to the device status and activity monitored (including sound and video, or any other sensor data) which it may store or process. Internet service 103 also transmits notifications to any or all of: a central monitoring station 104, a security company, a fire station (for certain embodiments of the invention in which the security device 102 further incorporates a smoke or heat detector), a police station or the software application 105. The notifications may include a notification that an intruder has been detected or sensor data including sound or images. The software application 105 may be installed upon a mobile device operated by an owner or operator of the intruder detection system 101, who may also be a person authorised to be in the detection space. Internet service 103 transmits signals to security device 102 relating to the status of software applications 105, as is described in greater detail below. It will be appreciated that the Internet service 103 may additionally be accessed by a user via any Internet enabled device, though transmitting notifications and sensor data to a software application 105 installed upon a user's mobile device has the advantage of providing more timely information to a user.

One or more instances of software application 105 may be installed by authorised users onto supported devices for instance phones and tablets. Specifically, every person who is authorised to be in a detection space, for instance a family member within a household, may have an instance of the software application 105 installed upon a mobile device that is associated with that user. Software application 105 implements parts of process described in FIG. 2 and allows authorised users to monitor and control the status of system 101 and to view notifications of unauthorised activity including audio and video recordings of the same.

The geographical location of device 102 may be inferred from its connection to the Internet service 103 or the location of software application 105 when in certain modes. The content of audio communications from loudspeaker 118 may reflect the location.

FIG. 2 illustrates a method of determining whether an authorised person is occupying (that is, located within) a detection space. The method may be implemented by the processing system 107, though in accordance with other embodiments the method FIG. 2 (and also the method of FIG. 3 to be described below) may instead be implemented by the Internet service 103.

At step 201 an occupancy list of authorised users known to be within or close to the detection space is maintained. The step of maintaining the occupancy list may be considered to be the default step. The occupancy list can be queried or provided as an input as part of a determination whether detected activity relates to an intruder, as is described below in connection with FIG. 3.

According to some embodiments, a software application 105 is installed by authorised users onto a mobile device for instance a mobile phone, smart phone, tablet, laptop or other electronic device they habitually carry with them. The software application 105 monitors a geographical location of the mobile device, for instance based on satellite navigation data or mobile or wireless network data to generate a notification when the device enters or leaves the geographic area of the detection space. The geographical area of the detection space may be the same as the detection space or it may be a broader geographical space encompassing or overlapping with the detection space (particularly where the detection space is relatively small compared with the granularity of geographical location data which can be obtained from the mobile device). The software application 105 may be arranged to send a notification to the security device 102 when the mobile device enters or leaves the detection space. Alternatively, the currently location of the mobile device may be periodically sent to the security device 102 such that the security device 102 can make the determination when the mobile device enters or leaves the detection space.

If at step 208 an input is received comprising a notification indicating that a mobile device with the software application installed has entered the geographical area of the detection space (or the security device makes that determination), the inference is that an authorised person has entered or is about to enter the detection space. At step 202 the user associated with that mobile device is added to the occupancy list and the process passes to step 201 where the occupancy list is maintained. Conversely, if at step 209 an input is received comprising a notification indicating that a mobile device with the software application installed has left the geographical area of the detection space (or the security device makes that determination), the inference is that an authorised person has left the detection space. At step 203 the user associated with that mobile device is removed from the occupancy list and the process passes to step 201 where the occupancy list is maintained. The determination of the location of an authorised person through determining whether a mobile device associated with that person is within a predetermined area may be referred to as “geo-fencing”, which will be familiar to the skilled person. According to some embodiments of the invention, several concentric geographical areas may be geo-fenced and notifications provided as the mobile device passes through each geo-fence such that greater confidence can be placed in a determination that a user has entered or left the detection space based upon the direction of their movement. Similarly, in certain embodiments of the present invention the location of the mobile device may be monitored to predict future occupancy of the detection space based upon the movement of a mobile device towards the detection space. In some geo-fencing implementations the actual location of a mobile device cannot be determined, only that it has crossed a geo-fence in one direction or another. If the geo-fence encircles an area then the determination is that the mobile device is either within that area or outside of that area, and no finer location information may be available. The present invention encompasses the notification at steps 208 and 209 being only that the mobile device has crossed a geo-fence and also current location information being provided to the security device 102, such that the security device can determine if the mobile device is in the geographical area of the detection space.

According to some embodiments, the presence of an authorised users' mobile device on a Wi-Fi or other similar wireless network within or close to the detection space may be monitored. Specifically, if a mobile device joins such a mobile network then that can be taken to indicate that a user associated with the mobile device has entered the detection space. According to one embodiment, transmissions can be broadcast on the network periodically to which potential mobile devices respond and are identified by communication with the software application 105 installed on them. Alternatively, the network equipment associated with the wireless network may directly inform the security device 102 that the mobile device is present on the network. Alternatively, the mobile device operating the software application may itself send a notification to the security device when it joins or leaves such a wireless network. If at step 204 a notification is received that the mobile device is found on the network, for instance when the user carries device to within range of a Wi-Fi access point, the user is added to the occupancy list at step 202. The network may comprise any form or wireless network in particular local area wireless network for instance Wi-Fi, Bluetooth, Bluetooth Low Energy or iBeacon. Direct transmission or transmission via another network device may be appropriate for peer to peer networks for instance Bluetooth where there is no network equipment.

Additionally, in response to the notification of step 204, a timer is started or restarted at step 205. When the timer expires, if the user's presence within the detection zone has not been confirmed at step 210 then at step 203 the user is removed from the occupancy list. Otherwise the list is maintained at step 201. Confirmation of the user's presence prevents a user from being removed from the occupancy list after a period of network inactivity even though they remain within the detection space. Confirmation may be via being found on the network again or via an independent mechanism, for instance by receipt of a geo-fencing notification as described above or by speaker recognition as described below.

This technique of determining occupancy through association of a mobile device to a wireless network helps ensure that an authorised user is recognised in the event of a problem with the determination of mobile device location used in step 208. Further alternative or complementary techniques may also be used to determine whether a mobile device is located within the geographical area of a detection space, for instance to compare the source IP address of a network connection originating from the software application 105 as seen from the public Internet with IP address connections associated with the Wi-Fi network. Further techniques for automatically establishing the location of a mobile device will also be well known to the skilled person and may be implemented as well as or instead of the techniques shown in FIG. 2.

The above discussion of FIG. 2 focuses on techniques to establish whether an authorised person is likely to be present within a detection space based upon the establishment of a location for a mobile device associated with that person. According to some embodiments, speaker recognition techniques may be used to directly determine whether an authorised person is present within or near a detection space. Speaker recognition matches the sound of an authorised user's voice in the detection space with a voice profile created and stored for the authorised person. Suitable commercial and open source speaker recognition and verification software is available. When a notification is received indicating that an authorised user's voice is recognised at step 206, the user is added to the occupancy list at step 202 and the occupancy list is maintained at step 201.

Additionally, in response to the notification of step 206, a timer is started or restarted at step 207. When the timer expires, if the user's presence within the detection zone has not been confirmed at step 210 via an independent mechanism, for instance by receipt of a geo-fencing notification or an indication of network activity as described above or via repeated speaker recognition, then at step 203 the user is removed from the occupancy list. This technique could be used when a user does not have an operational device with application 105 installed.

Speaker recognition is one example of a biometric identification technique, and others will be readily apparent to the skilled person, for instance finger print recognition and face recognition, which may make use of a camera 113 within the security device. In other embodiments, the techniques illustrated in FIG. 2 may be supplemented or replaced in part by other techniques beyond biometric identification or identification of a location of a mobile device: for instance RFID/radio tags carried by users and user input for instance through a keypad or software application. It will be understood however that techniques requiring user interaction are not preferred.

As discussed above, activity with a detection space may be determined through the use of a range of sensors and sensing techniques. The present invention is not limited to any particular technique for detecting activity within a detection space, though certain suitable sensors and techniques will now be described. It is assumed that the skilled person is familiar with conventional sensing techniques; in particular those frequently used by intruder detection systems to determine the presence of an intruder. In addition, the following techniques described in detail below are focussed on detecting a human within a detection space. In the alternative, activity may be detected through a sensor arranged to detect a human crossing a perimeter surrounding the detection space, for instance by opening or breaking a door or window.

According to certain embodiments of the present invention, data from sensors or other data which might be indicative of human activity may be captured, stored and later processed to identify sensor data that is not indicative of human activity and so can be ignored in future, as is described below in connection with FIG. 3. In particular embodiments of the invention the sensors may include sensors arranged to sense activity without requiring that the sensor is in line of sight to the location of the activity, for instance by detecting sound or changes in air pressure.

According to some embodiments, a microphone is used to monitor sounds within the audible range. Changes in the overall sound level or the recognition of specific sounds for instance voices, glass breaking, opening and closing of doors and footsteps may be used to infer a likelihood of human activity in the detection space. Two or more microphones may be used and the phase difference in signals detected by each used to determine the direction of the sound source. Various techniques including, but not limited to, cepstral analysis and wavelet analysis can be used to derive coefficients representative of the characteristics of a set of sample recordings of a target sound and the monitored sounds subjected to similar analysis to test for a match. A sequence of increasingly computationally expensive matching stages, in which the subsequent stage runs only when the preceding stage finds a match, can minimise the computational demands of providing high fidelity matching.

According to some embodiments, a microphone is used to monitor sounds out of the audible range (ultrasound and infrasound). Air moving due to human movement, deflection of floorboards and doors moving create sound outside the range of human hearing. Changes in the overall sound level or the recognition of specific sounds may be used to infer a likelihood of human activity in the enclosure.

According to some embodiments, noise on the mains power line is monitored. The use of electrical switches and certain electrical devices in operation create noise on the power main which may be detected. Detected electrical noise may indicate a likelihood of human activity in the detection space, or it may be categorised as being not indicative of human activity such that it is ignored. Criteria for determining power line noise likely to indicate human activity is pre-programmed and may be updated by activity monitored. As an example, the temperature related automated switching of a refrigerator may be interpreted as not indicating human activity, whereas a television switching on or off may indicate human activity. Detected power line noise may be characterised and noise of the same character filtered out in future if it is determined that it is not indicative of human activity.

According to some embodiments, traffic on a computer network within an enclosure, for instance a home Wi-Fi network, is monitored. Traffic for instance web browser connections originating on the network can indicate human activity in the detection space. Criteria for determining traffic likely to indicate human activity is pre-programmed and may be updated by traffic monitored. For example, traffic generated by background processes on an unattended computer may occur when the detection space is unoccupied. Such traffic may be characterised and traffic of the same character filtered out in future.

According to some embodiments, a light sensor can detect the presence of artificial and natural light. Sudden changes in ambient light levels can indicate activity for instance the switching on and off of lights or the opening or closing of curtains. The wavelength composition of light can be measured to distinguish the presence of artificial lighting which can indicate human activity as opposed to daylight, changes in which may be simply explained by sunrise and sunset.

According to some embodiments, a motion sensor for instance a passive infrared motion sensor can be used to detect movement of objects which can indicate human activity.

According to some embodiments, a camera can be used to detect movement in its field of view which can indicate human activity.

According to some embodiments, a software application 105 installed on an authorised user's mobile device monitors the state of the device for changes that can indicate human activity in the enclosure. According to certain embodiments of the invention activity by authorised persons within the detections space may be detected based on monitoring signals sent from a device carried by an authorised person. A gyroscope, accelerometer, magnetometer or inertial measurement unit in the device or geographic location data (as discussed above) by the device can indicate movement, position and orientation of the device from which the activity of a human carrying the device can be inferred. Detecting the charging of the device battery can indicate that the device is not being carried by a human.

Referring now to FIG. 3, this illustrates a method of determining whether detected activity relates to an unauthorised person.

At step 301 an input is received relating to potential activity. For instance, the received signals obtained from one or more of the types of sensors described above. The sensor inputs may be monitored over time. At step 302 signals relating to potential activity are sequenced to form an activity pattern. A series of recognition algorithms are used to identify characteristic sensor data signatures indicative of predetermined types of activity which may be a specific activity (e.g. breaking glass, opening of a door/window, footsteps) or a more general activity signal (for instance, audio with associated frequency spectrum and power). The activities identified are sequenced in chronological order, each with its identified activity type, associated time of occurrence and data relating to the characterization of the signal (e.g. spectrum of sound or type of network traffic). Generation of an activity pattern may use a rolling time window to produce various patterns commencing from different points in time but that share certain activity signals. The more general activity signals may be used by the subsequent rule matching stage when considered as part of an activity pattern containing specific activities: that is to determine whether specific activities are preceded or followed by activity typical within the detection space.

At step 303 the generated activity patterns are matched against a set of rules provided as an input 312 to the matching step 303. Each rule indicates that a matching pattern be regarded either as related or not related to an unauthorised person.

Accordingly, the output of the matching step 303 is that the activity pattern is matched to either an authorised person or an unauthorised person or that the activity pattern is not matched. A rule may take account of multiple types of sensor data. Examples of rules include: a rule indicating that glass breaking sounds be regarded as related to an unauthorised person entering the detection space; and a rule indicating that an activity pattern corresponding to detected infrasound indicative of a door or window being opened followed by detected air pressure changes indicative of a door or window being opened be regarded as related to an unauthorised person. A determination of whether a detected activity pattern relates to the presence of an unauthorised person may take account of the current time of day or day of week and the time of day or day of week of previous occurrences.

According to some embodiments, a rule may include criteria for the present state of the occupancy list as generated according to the method described above in connection with the flowchart of FIG. 2. As such, the occupancy list is provided to the matching step 303 as an input 304. As one example, a rule may indicate that an activity pattern corresponding to detected sound indicative of footsteps be regarded as not related to an unauthorised person (that is, it is assumed that the footsteps sound is generated by an authorised person) when the occupancy list input 304 indicates that the occupancy list contains at least one authorised person within the detection space. The occupancy list input 304 may indicate not only whether there is an authorised person within the detection space, but also the number of authorised persons or the identities of the authorised persons. It will be appreciated that different authorised persons may typically cause different activity patterns. Knowledge of the identity of the authorised person may be beneficial in determining the probability that an activity pattern relates to an unauthorised person (through the probability model input 310, discussed below).

According to some embodiments, a rule may include criteria for the number of previous occurrences of an activity pattern. An occurrence count input 311 is provided as an input to the matching step 303 indicating a count of previous occurrences of one or more of the activity patterns. The occurrence count may indicate an absolute number of occurrences, a count of occurrences within a predetermined period of time (which may be a sliding time window) or an count of occurrences according to some other criteria, for instance while the occupancy list indicates that the detection space is empty. As one example, a rule may indicate that sounds that occur regularly when the occupancy list is empty be regarded as not related to an unauthorised person. Such a rule can prevent the sound of footsteps in an adjoining apartment or air movement caused by a pet dog causing false determinations. Such a rule may also take account of the magnitude and frequencies of sensor inputs, for instance to distinguish between footsteps in an adjoining apartment (to be ignored) and footsteps within the detection space (indicative of the presence of an unauthorised person if the occupancy list is empty).

According to some embodiments, a rule may include criteria for the estimated probability of an activity pattern occurring at the current time. A probability model 310 is provided as an input to the matching step 303. As one example, a rule may indicate that an activity pattern indicative of an external door being opened should be regarded as not related to an unauthorised person if preceded by other activity for which the estimated probability of occurrence at that time is high. Such a rule considers the typical pattern of activity for authorised persons within a detection space. For example, when the detection space comprises a dwelling, an authorised user awaking around the time they typically do on that day of week, coming down some stairs and opening a door to let in some air can be differentiated from an intruder opening the same door at a time authorised users are typically sleeping. It will be appreciated that this example of a rule may take account of time and day of the week information, previous activity patterns, sensor input to detect movement within the detection space (for instance microphone data) and sensor input to detect opening of a door or window (for instance data from an air pressure sensor).

The probability that a generated activity pattern is due to an unauthorised person present within the detection space is 1 minus the probability of an authorised person causing that activity pattern. This determination is achieved by the security device recording activity patterns that occur in the detection space over time in order to learn typical activity patterns associated with authorised persons. To determine whether a newly occurring activity pattern results from an unauthorised person, the security device uses the probability of that activity pattern occurring at that time according to the current state of the occupancy list.

According to some embodiments, a rule may include criteria for weather conditions at the location to prevent activity related to atmospheric changes, disturbances and meteorological phenomena being classified as human activity. Such a criterion may take account of data obtained from a weather sensor. Alternatively, the weather information may be obtained from a weather monitoring or forecasting service over the Internet, with that data being provided as an input to the matching step 303 (not shown in FIG. 3). More generally, matching activity patterns to rules may take account of other data obtained from a remote source, for instance a remote server or from the software application 105 installed upon a mobile device associated with an authorised person.

Criteria may be combined in rules. For instance, a rule indicating that activity indicative of an external door being opened where the occupancy list contains at least one authorised person and the probability of activity that preceded it occurring at that time is high, but did not previously occur immediately before an activity pattern indicative of an external door being opened, be regarded as related to an unauthorised user. Such a rule can identify an unauthorised opening of a door from the outside even when authorised users are active within the enclosure by checking for the typical activity pattern (for instance, sounds) of footsteps approaching the door from the inside that has occurred on the previous occasions the door has been opened when authorised users are active.

If the result of the matching step 303 is that an activity pattern is regarded as not related to an unauthorised person or matches no rule, according to certain embodiments of the invention that result may be used to update any or all of the rules 312, record of occurrences 311 and probability model 310 at update step 313, 314, 315.

The step of updating the rules 313 may, for instance, include updating a baseline or threshold sound level in a rule criteria based on monitored sound levels.

The step of updating the record of occurrences 314 may, for instance, include updating a database which stores the number and date or time of occurrences of activity patterns according to monitored activity patterns.

The step of updating the probability model 315 may, for instance, include updating a statistical model of activity patterns when an activity pattern is regarded as not related to an unauthorised person or matches no rule. The model may be based in part on the calendar (time of day, day of week, national holidays or seasons) and the state of the occupancy list when the activity was monitored. The model allows the probability of an activity pattern commencing at a point in time to be estimated based on the previously monitored activity. In this way typical activity patterns in the detection space are learned and criteria based upon typical activity patterns may be used to determine the nature of a generated activity pattern. When the typical activity patterns in the detection space change, for instance when an occupant begins to wake and leave the enclosure earlier to accommodate a new job, the earlier activity on work days updates the probability model and probabilities it estimates such that the new activity patterns are learned.

According to some embodiments, when an activity pattern is regarded as related to an unauthorised person, before further action is taken it is first checked at step 306 against a database of ignored patterns provided as an input 316. If the matched activity pattern matches certain criteria in the database of ignored patterns 316 no further action is taken and the method ends at step 318 unless or until a new sensor input is detected at step 301. Otherwise a response is triggered at step 307. The response may comprise alerting one or more authorised person, for instance through the software application 105 installed upon an authorised persons mobile device. At step 308 an alerted authorised person may choose to cancel the determination that a matched activity pattern relates to an unauthorised person. If an authorised person cancels the response then at step 317 the database of ignored patterns is updated. In addition, the update of the ignored matched activity patterns may take account of any or all of: the state of the occupancy list and calendar information (time of day, day of week, national holidays or seasons). However, if an authorised user does not cancel the response at step 308 then an alarm is generated at step 319. The alarm may comprise an audible or visible signal within the detection space, contacting a monitoring station or emergency services 104 or any other action that is suitable for an intruder detection system, examples of which will be apparent to the skilled person. In certain embodiments, if at step 306 there is no indication to ignore a matched activity pattern then an alarm can be generated immediately, with no warning period. Optionally, the user may be able to cancel the alarm at step 308. Whether or not there is an immediate alarm may depend on the current occupancy list 304. Alternatively, there may be a warning period before an alarm is generated, though a user may be able to cancel the alarm at step 308 either during the warning period or after the warning period expires. Cancelling of an alarm at step 308 may or may not update the ignored activity patterns irrespective of whether the alarm is cancelled before or during activation.

It will be appreciated that embodiments of the present invention can be realized in the form of hardware, software or a combination of hardware and software. Any such software may be stored in the form of volatile or non-volatile storage, for example a storage device like a ROM, whether erasable or rewritable or not, or in the form of memory, for example RAM, memory chips, device or integrated circuits or on an optically or magnetically readable medium, for example a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium, for example a communication signal carried over a wired or wireless connection and embodiments suitably encompass the same.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. It will be also be appreciated that, throughout the description and claims of this specification, language in the general form of “X for Y” (where Y is some action, activity or step and X is some means for carrying out that action, activity or step) encompasses means X adapted or arranged specifically, but not exclusively, to do Y.

The reader's attention is directed to all papers and documents which are filed concurrently with or previous to this specification in connection with this application and which are open to public inspection with this specification, and the contents of all such papers and documents are incorporated herein by reference.

1. A method of detecting an unauthorized person, the method comprising:
monitoring an indication of whether an authorized person is present within a detection space;
receiving a sensor input relating to activity within the detection space; and
wherein if the monitoring indicates that an authorized person is present within the detection space, the method further comprises comparing the generated activity pattern against a set of rules to determine whether an unauthorized person is present within the detection space.

2. A method according to claim 1, wherein determining whether an unauthorized person is present within the detection space comprises:
comparing detected activity to activity associated with the presence of an authorized person within the detection space; and
determining whether an unauthorized person is present within the detection space based upon the result of that comparison.

3. A method according to claim 1, wherein monitoring an indication of the presence of an authorized person within the detection space comprises:
identifying at least one authorized person whose presence within the detection space is indicated; and
wherein determining whether an unauthorized person is present within the detection space comprises or further comprises:
comparing detected activity to activity associated with the presence of at least one identified authorized person within the detection space; and
determining whether an unauthorized person is present within the detection space based upon the result of that comparison.

4. A method according to claim 1, wherein if activity is detected within the detection space and the monitoring indicates that there are no authorized persons present within the detection space, the method further comprises
determining based on the detected activity whether an unauthorized person is present within the detection space.

5. A method according to claim 1, wherein the determination is further based on an indication that an authorized person is approaching the detection space.

6. A method according to claim 1, wherein determining whether an unauthorized person is present within the detection space comprises:
comparing detected activity to activity previously determined to indicate the presence of an unauthorized person within the detection space or comparing detected activity to activity previously determined to not indicate the presence of person within the detection space; and
determining whether an unauthorized person is present within the detection space based upon the result of that comparison.

7. A method according to claim 1, wherein if it is determined that there is not an unauthorized person present within the detection space, the method further comprises:
updating a list of activity associated with the presence of an authorized person within the detection space;
updating a list of activity associated with the presence of an identified authorized person within the detection space; or
updating a list of activity associated with there being no unauthorized person
present within the detection space.

8. A method according to claim 1, wherein the determination whether an unauthorized person is present within the detection space is further based upon a number, type or time of occurrence of previously detected activities.

9. A method according to claim 1, wherein determining whether an unauthorized person is present within the detection space comprises determining a probability of an unauthorized person being present within the detection space.

10. A method according to claim 1, wherein if it is determined that an unauthorized person is present within the detection space, the method further comprises:
triggering an audible or visible alarm signal; or
sending an alert to an authorized person or a third party.

11. A method according to claim 1, wherein if it is determined that an unauthorized person is present within the detection space, the method further comprises:
comparing the detected activity to a list of at least one activity predetermined to be ignored;
wherein if the result of the comparison is that the detected activity matches an activity to be ignored then the determination that an unauthorized person is present within the detection space is reversed;
wherein if the result of the comparison is that the detected activity does not match an activity to be ignored then the method further comprises sending an alert to an authorized person or a third party; and
wherein if in response to the alert a message is received indicating that the activity is to be ignored then the method further comprises:
reversing the determination that an unauthorized person is present within the detection space; and
adding the detected activity to the list of activity to be ignored.

12. A method according to claim 1, wherein monitoring an indication of the presence of an authorized person within a detection space comprises:
monitoring the location of a mobile device associated with an authorized user and determining whether the mobile device is within a geographical area at least partially overlapping the detection space;
determining whether a mobile device associated with an authorized user is connected to a wireless network proximal to the detection space; or
recognizing the voice of an authorized person within the detection space.

13. A method according to claim 10, further comprising:
maintaining an occupancy list indicating authorized persons whose presence is indicated in the detection space;
wherein if the presence of an authorized person is indicated by determining whether a mobile device associated with an authorized user is connected to a wireless network or by recognizing the voice of an authorized person, the method further comprises:
determining whether the presence of the authorized person within the detection space is confirmed within a predetermined time period, and if not removing the authorized person from the occupancy list.

14. A method according to claim 1, wherein detecting activity within the detection space comprises receiving a signal from a sensor arranged to sense activity within the detection space.

15. A method according to claim 14, further comprising identifying characteristic sensor data indicative of a predetermined activity pattern or generating an activity pattern indicative of the sensor signal or variation of the sensor signal.

16. A method according to claim 14, wherein the sensor is arranged to sense:
space;
audible or inaudible sound;
changes in air pressure;
changes in the power supply of electrical or electronic devices within the detection signals sent from a device carried by an authorized person; or
movement.

17. A security device arranged to detect an unauthorized person, the security device comprising:
a processing system arranged to:
monitor an indication of whether an authorized person is present within a detection space;
receive a sensor input relating to activity within the detection space; and
generate an activity pattern from the sensor input;
wherein if the monitoring indicates that an authorized person is present within the detection space, the processing system is further arranged to compare the generated activity pattern against a set of rules to determine whether an unauthorized person is present within the detection space.

18. A security device according to claim 17, further comprising:
a network interface arranged to receive an indication of the location of a mobile device associated with an authorized user;
wherein the processing system is arranged to monitor an indication of the presence of an authorized person within the detection space by determining whether the mobile device is within a geographical area at least partially overlapping the detection space.

19. A security device according to claim 17, further comprising:
a sensor arranged to sense activity within the detection space;
wherein the processing system is arranged to detect activity within the detection space based upon activity sensed by the sensor.

20. A security device arranged to detect an unauthorized person, the security device comprising:
a processing system arranged to:
monitor an indication of whether an authorized person is present within a detection space;
receive a sensor input relating to activity within the detection space; and
generate an activity pattern form the sensor input;
at least one sensor arranged to sense activity within the detection space, the at least one sensor being selected from the group consisting of: air pressure sensor, motion sensor, camera, microphone, and light sensor;
wherein if the monitoring indicates that an authorized person is present within the detection space, the processing system is further arranged to compare the generated activity pattern against a set of rules to determine whether an unauthorized person is present within the detection space.
